(19) United States
(12) Patent Application Publication
(10) Pub. No.: US 2012/0030581 A1
(43) Pub. Date: Feb. 2, 2012

(54) Mashup Component Framework for Business Enterprise User Interfaces

(76) Inventors: Weiyi Cui, Shanghai (CN); Xiao Xu, Wujiang (CN); Gregor Karl Frey, Lorsch (DE); Karsten Fanghänel, Schwetzingen (DE); Sven Schwerin-Wenzel, Dielheim (DE); Zhijian Wang, Shanghai (CN); Matthias Lehr, Weinheim a.d.B. (DE); Stefan A. Baeuerle, Rauenberg (DE)

(21) Appl. No.: 12/845,270

(22) Filed: Jul. 28, 2010

(51) Int. Cl. G06F 3/01

(52) U.S. Cl. 715/744

(57) ABSTRACT

According to some embodiments, a business user interface page associated with a business service provider may be established. The user interface page may have, for example, at least one in-port to receive data from components and at least one out-port to provide data to components. A mashup component may be embedded within the business user interface page, and may also have at least one out-port to provide data to components. A display of the user interface page to a client may then be facilitated, including the embedded mashup component, wherein the mashup component combines and displays data received from a plurality of external data sources.

### FIELD

Some embodiments relate to a service-oriented architecture to provide business enterprise user interfaces. More specifically, some embodiments provide a framework for supporting mashup components in connection with a service-oriented architecture.

### BACKGROUND

An enterprise might store and access business information in a number of different ways. For example, an enterprise might store a substantial amount of information about production, sales, human resources, etc. in one or more database structures created by a business service provider (e.g., SAP AG® or SalesForce®). In some cases, a business service provider hosts and provides business services for a client 120. For example, the business service provider might receive requests from the client and provide responses to the client via a service-oriented architecture such as those provided by SAP Business ByDesign® or Salesforce®. In this way, the client may access information via one or more business user interface displays. The use of the remotely hosted business process platform may help the client avoid the costs and problems associated with maintaining a local, “in house” Enterprise Resource Planning (ERP) system.

Note that an enterprise might want to let users access information via a web “mashup” display (e.g., a display that combines data from multiple sources into a single integrated tool). For example, cartographic mapping data from Google Maps® might be combined with delivery addresses of outstanding purchase orders on a display. Manually integrating mashup information into a business user interface display, however, can be a time consuming process. Moreover, it can be difficult to let the client adjust the presentation of mashup information based on the client's business needs (e.g., one client might prefer to view one mashup display while another client prefers to view a different mashup display).

Accordingly, a method and mechanism for efficiently integrating mashup displays into business user interfaces may be provided by some embodiments herein.

### BRIEF DESCRIPTION OF THE DRAWINGS

FIG. 1 is a block diagram of a system according to some embodiments.

FIG. 2 is an example of a business user interface page in accordance with some embodiments.

FIG. 3 is a flow diagram of a process according to some embodiments.

FIG. 4 illustrates some integration types and mashup components in accordance with some embodiments described herein.

FIG. 5 is a block diagram of some mashup components at run time.

FIG. 6 is a system architecture according to some embodiments.

FIG. 7 illustrates an end user mashup personalization side panel associated with a URL mashup according to some embodiments.

FIG. 8 illustrates an end user mashup personalization side panel associated with a data mashup according to some embodiments.

FIG. 9 illustrates an end user mashup personalization side panel associated with an HTML mashup according to some embodiments.

FIG. 10 is a block diagram of a mashup platform according to some embodiments.

FIG. 11 is a tabular example of a mashup component database according to some embodiments.

### DETAILED DESCRIPTION

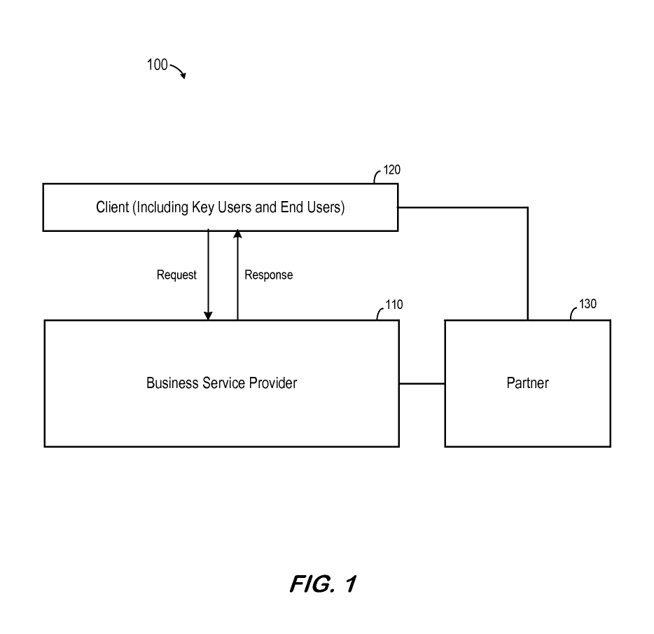

An enterprise might store and access business information in a number of different ways. For example, an enterprise might store a substantial amount of information about production, sales, human resources, etc. in one or more database structures created by a business service provider (e.g., SAP AG® or SalesForce®). FIG. 1 is a block diagram of a system 100 according to some embodiments. In this case, a business service provider 110 might host and provide business services for a client 120. For example, the business service provider 110 might receive requests from the client 120 and provide responses to the client 120 via a service-oriented architecture such as those provided by SAP Business ByDesign® or Salesforce®. The use of the remotely hosted business process platform may help the client 120 avoid the costs and problems associated with maintaining a local, “in house” ERP system.

The client 120 may be associated with a Web browser to access services provided by business process platform 110 via HyperText Transport Protocol (HTTP) communication. For example, a user may manipulate a user interface of the client 120 to input an instruction (e.g., “show me a sales report”). The client 120, in response, may transmit a corresponding HTTP service request to the business service provider 110 as illustrated. A service-oriented architecture may conduct any processing required by the request (e.g., generating views and user interfaces) and, after completing the processing, provides a response to client 120. The client 120 might comprise a Personal Computer (PC) or mobile device executing a Web client. Examples of a Web client include, but are not limited to, a Web browser, an execution engine (e.g., JAVA, Flash, Silverlight) to execute associated code in a Web browser, and/or a dedicated standalone application.

Note that FIG. 1 represents a logical architecture for describing processes according to some embodiments, and actual implementations may include more or different components arranged in other manners. Moreover, each system described herein may be implemented by any number of devices in communication via any number of other public and/or private networks. Two or more of devices of may be located remote from one another and may communicate with one another via any known manner of network(s) and/or a dedicated connection. Moreover, each device may comprise any number of hardware and/or software elements suitable to provide the functions described herein as well as any other functions. Other topologies may be used in conjunction with other embodiments.

All systems and processes discussed herein may be embodied in program code stored on one or more computer-readable media. Such media may include, for example, a floppy disk, a CD-ROM, a DVD-ROM, a Zip® disk, magnetic tape, and solid state Random Access Memory (RAM) or Read Only Memory (ROM) storage units. Embodiments are therefore not limited to any specific combination of hardware and software.

The business service provider 110 might store client information into and retrieve client information from one or more database structures, such one or more “business objects.” As used herein, the phrase “business object” may refer to a set of entities with common characteristics and common behavior representing a defined business semantic. Note that business data may be stored within physical tables of a database. The database may comprise a relational database such as SAP MaxDB, Oracle, Microsoft SQL Server, IBM DB2, Teradata and the like. Alternatively, the database could be a multi-dimensional database, an eXtendable Markup Language (XML) document, or any other structured data storage system. The physical tables may be distributed among several relational databases, dimensional databases, and/or other data sources.

One or more “partners” 130 may also be associated with the business service provider 110 and/or client 120. The partner 130 may, for example, develop third party applications and/or business “user interfaces” to facilitate access to business information by the client. Note that the client 120 might interact with database structures hosted by the business service provider 110 via one or more such business user interfaces (e.g., created by the business service provided 110 or by a partner 130). Also note that a single client 120 might be associated a number of different users. For example, “end users” might represent employees of the client 120 who access information from the business service provider 110 as part of their day-to-day work (e.g., to enter information about sales or to monitor financial information). The client 120 might also include one or more “key users” who customize existing business user interfaces and/or create new business user interfaces for end users.

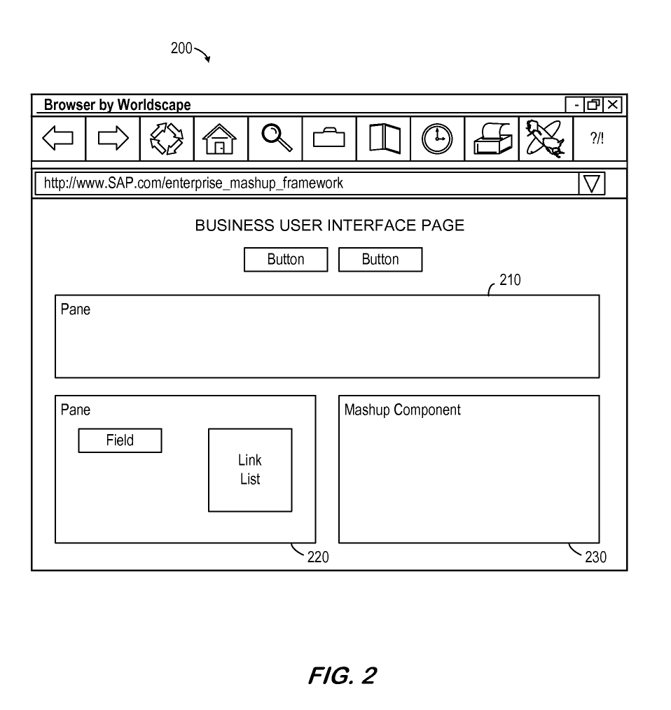

In some cases, the client 120 might want to let users access certain types of information via a web “mashup” display (e.g., a display that combines data from multiple sources as a single integrated tool). For example, FIG. 2 is an example of a business user interface page 200 in accordance with some embodiments. The business user interface 200 might include one or more typical display panes 210, 220 (e.g., including individual fields, link lists, and buttons). The business user interface 200 may, according to some embodiments, also include a mashup component 230. The mashup component 230 might, for example, combine cartographic mapping data from Google Maps® with delivery addresses of outstanding purchase orders. Other types of mashup components might be associated with, for example, context sensitive Really Simple Syndication (RSS) feed integration, social network integration, data completion via external services, and/or web widgets.

Manually integrating mashup information into the business user interface 200, however, can be a time consuming process. Moreover, it can be difficult to let a client adjust the presentation of the mashup component 230 based on the client's business needs (e.g., one client might prefer to view one mashup display while another client prefers to view a different mashup display). Accordingly, a method and mechanism for efficiently integrating mashup displays into business user interfaces may be provided by some embodiments herein.

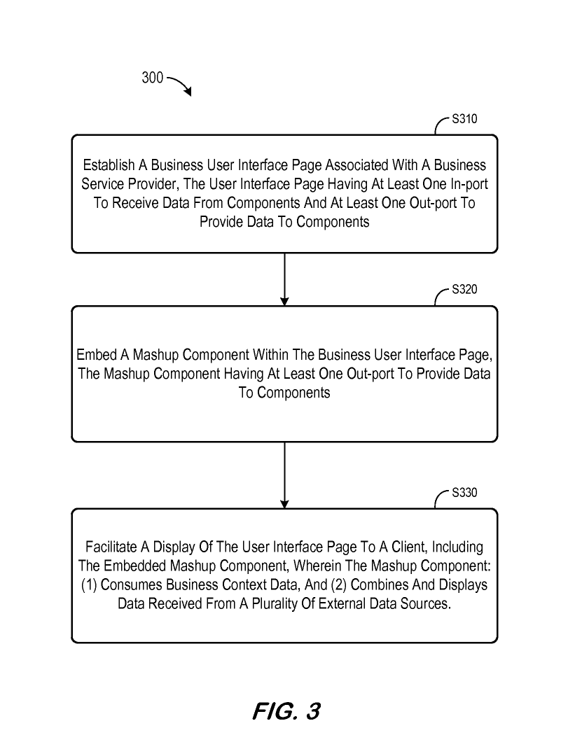

In particular, FIG. 3 is a flow diagram of a process 300 according to some embodiments. The business service provider 110 and/or client 120 may execute portions of the process 300 as will be described below, but embodiments are not limited thereto. In this regard, all processes described herein may be executed by any combination of hardware and/or software. The processes may be embodied in program code stored on a tangible medium and executable by a computer to provide the functions described herein. Further note that the flow charts described herein do not imply a fixed order to the steps, and embodiments of the present invention may be practiced in any order that is practicable.

At S310, a business user interface page associated with a business service provider may be established. As will be described herein, the user interface page may have “in-ports” to receive data from components and “out-ports” to provide data to components. A mashup component may be embedded within the business user interface page at S320. The mashup component may also have in-ports to receive data from components and out-ports to provide data to components. Note that mashup component might be associated with, for example, C#, XAML, HTML, JavaScript, or XML. Moreover, the mashup might be provided in an external browser window or be embedded (e.g., as an HTML/JavaScript control).

At S330, a display of the user interface page to a client may be facilitated, including the embedded mashup component. Moreover, the mashup component may consume business context data and combine and display data received from a plurality of external data sources. According to some embodiments, the mashup component is further associated with write-back data from a user selection to the business user interface page.

Note that, according to some embodiments, key user personalization data may be received from the client, and the facilitating of the display of the user interface page performed at S330 is performed in accordance with said key user personalization data. Similarly, end user personalization data may be received from the client, in which case the facilitating of the display of the user interface page may be performed in accordance with the end user personalization data.

Such an approach may let a key user configure and add new mashup components to business service provider pages, and allow an end user to use these components like other components provided by the business service provider. As a result, substantially configurable, generic mashup components may be generated in connection with a wide variety of external services. In addition, partners may be enabled to develop new components for completely new kinds of services along with new ways of graphically displaying such information.

According to some embodiments, key users may perform the technical configuration of these components (e.g., by mapping parameters and adding them to business information pages). This configuration might be applied client-wide. An end user may personalize the pages that carry mashup components in the same way as he/she does with other types of business information pages. According to some embodiments, an end user might be given the key user tools for the configuration of mashup components. In the hands of an end user (without special key user rights), the configuration tools might only change his or her personal settings (and not effect other end users).

According to some embodiments, a partner may create a mashup service adapter and template for mashup components. Note that a mashup component might comprise a user interface component that calls an external service and maps out-going and in-going parameters from and to other user interface components. A template for a mashup component might comprise, for example, a partially configured mashup component which is not meant to be complete and usable by itself (e.g., further configuration night be needed before it can be provided to end users).

A mashup component might be, according to some embodiments, configured by an Extensible Markup Language (XML) file that adheres to the rules for user interface components. It may further refer to a mashup service adapter, such as a Silverlight class that inherits from AbstractCustomPane. Note that Microsoft Silverlight is a web application framework that provides functionalities integrating multimedia, graphics, animations and interactivity into a single runtime environment.

The mashup service adapter might also contain the coding for calling a service or a class of services, mapping in-going and out-going parameters, and transforming data types as required by the service or class of services. It might, for example, use the Application Programming Interfaces (APIs) provided by AbstractCustomPane to send and receive events to/from the user interface controller, and access the configuration data given in the XML-file.

The development of mashup service adapters might require Silverlight specific design time tools. The template for the XML-configuration of a mashup component could be created by using any text editor, but according to some embodiments a XML-aware editor may be used. Note that creation of mashup service adapters (as well as of templates for mashup components) could be done by a business service provider, a partner, and/or a client.

Note that mashup components may combine many different types of information. For example, a mashup component might call external search engines using the Uniform Resource Locator (URL) of the search service along with the search parameters from the configuration. The mashup component may then launch a HTTP request and display the search results in a new browser window. As another example, a mashup component might retrieve items from an RSS/Atom-feed using the URL of the RSS/Atom-feed as well as optional filter parameters from the configuration. The mashup component may then launch an HTTP request and display the items received in a view within the embedding user interface component.

Note that calling an external service from within a Silverlight application running in a browser plugin may raise security considerations. For example, a network access to any other endpoint other then the server providing the application might normally be forbidden. According to some embodiments, access is granted only if the endpoint provides the right type of policies. In addition, the content of outgoing requests and incoming responses may need filtering to withhold confidential information. Note that in some cases, an external service might require dedicated authentication, a client certificate might be needed, and use of Single Sign-On (SSO) access control may be utilized.

According to some embodiments, mashup components are loaded into the business service provider user interface, which runs in the browser on the user's PC. As a result, the mashup component could substantially degrade the responsiveness of the user interface. For mashup components provided by a partner, a business service provider might certify components after evaluating the component's behavior with respect to any performance impact.

According to some embodiments, a client's key user might provide both technical service configurations and user interface configurations for a mashup component.

Technical Service Configuration by Key User

Note that mashup components may be derived from templates delivered either by a business service provider or as an add-on delivered by a partner. These templates might be made available in a backend repository of the business service provider and accessed by runtime authoring tools from within the user interface. By using these runtime authoring tools, the configuration of templates may be completed. Where the template might leave the name of parameters and services, URLs, security settings, transformation rules and other configuration items open, the final mashup component may need to carry this information so it can be used in a mashup together with other user interface components. This configuration step may make a mashup configuration ready to be embedded in and wired to other business user interface components. Note that it may be independent of the location where it finally will be used. The runtime authoring tools used to configure mashup components might comprise, for example, a simple XML-editor, graphical editors, drag and drop functions, or a step-by-step wizard.

By way of example, parameters for a mashup component to call external search engines might include: the URLs of the engines, the parameter pattern that is appended to the URL, the defaulting, and the binding of these parameters to data types of in-ports of the component. When configuring a search engine call, for example, the final URL HTTP request might need the following configuration data:

Display Name: Google Search

Base-URL: www.google.de/search

Parameter-Pattern: “hI={0}&q={1}”

Parameter 0: bound to parameter “language” in port-type (or data-model)

Parameter 1: bound to parameter “search expression” in port-type

According to some embodiments, the runtime authoring tool for a key user comprises a wizard that asks for the relevant configuration data in three steps: (1) enter the name of the service, (1) parse an example URL (in which case the Base-URL and Parameter-Pattern may be determined from a paradigmatic call), and (3) drag parameters from in-ports and drop them on corresponding URL-parameters.

Note that the configuration for Simple Object Access Protocol (SOAP) web-services may be more complex. For example, a SOAP operation may include outbound and inbound XML-messages, which might be deeply nested and use any XSD-data type. A generic mashup component, that allows the consumption of any arbitrary SOAP web service, might therefore require complex configuration tools. According to some embodiments, only SOAP services that have “flat” outgoing and ingoing message structures may be supported.

User Interface Configuration by Key User

The result of the technical service configuration described above may be a configured mashup component, which “knows” how to address, parameterize, and display an external service. What may still be missing, however, is an association of these mashup components to specific pages and their wiring to ports of other user interface components, either other “normal” components or other mashup components. This task might also be performed by a key user via runtime authoring tools.

A key user (e.g., a user who that has been given special rights for configuring pages), may be enabled to open a page configuration panel (e.g., displayed in a “side-car” fashion). This configuration panel might, for example, display all available mashup components that “fit” a given page. A mashup component might fit a page, for example, if it uses inbound PortTypes that are the same as outbound PortTypes on the page (or vice versa, if it provides outbound PortTypes that are the same as inbound PortTypes on the page).

The key user might select from the configuration panel the mashup components that are meaningful in the business context of this page according to client policies. For example, the license for an external service might be expensive and the costs might depend on the volume of calls. In such cases, the key user might be restrained and assign this service only to a well-selected set of pages.

If a key user selects a mashup component for a given page, the wiring of inbound plugs from the mashup component to outbound plugs from the user interface components on the page (and vice versa), might be done automatically, according to some embodiments, when only one wiring result is possible. If there are multiple potential wiring solutions (e.g., there are two components on a page that provide addresses), a manual selection by the key user might be required.

Note that some embodiments may require the consistent use of data types, which may be shared between all types of user interface components. According to some embodiments, a key user may choose to see all mashup components, including those that do not “fit” a particular page. In case of non-fitting data types, the tool might let a key user manually map ingoing and outgoing parameters, regardless of data types.

According to some embodiments, the runtime authoring tool gives the key user additional options to layout the page that includes mashup components. For example, the position of a mashup component might be altered, or the mashup component might be made visible (or invisible) by default.

Note that the key user configurations described herein might be applied client-wide (e.g., for all end users). Some examples mash components might include: a list of search service added to a page's toolbar; a link to open a geographical map in a new browser window, which uses the company address of a supplier as parameter; a view that displays news from an RSS-feed, filtered by the company name; a view that displays a geographical map together with analytical business data (e.g., sales figures for all European countries).

Mashup Component Framework

Thus, embodiments described herein may efficiently enable mashups and extend user interfaces based on pre-defined user interface characteristics (e.g., port-types and ports) in the form of mashup services and user interface components. Moreover, a business service provider, partner, or client may design new user interfaces including mashups based on internal and external data.

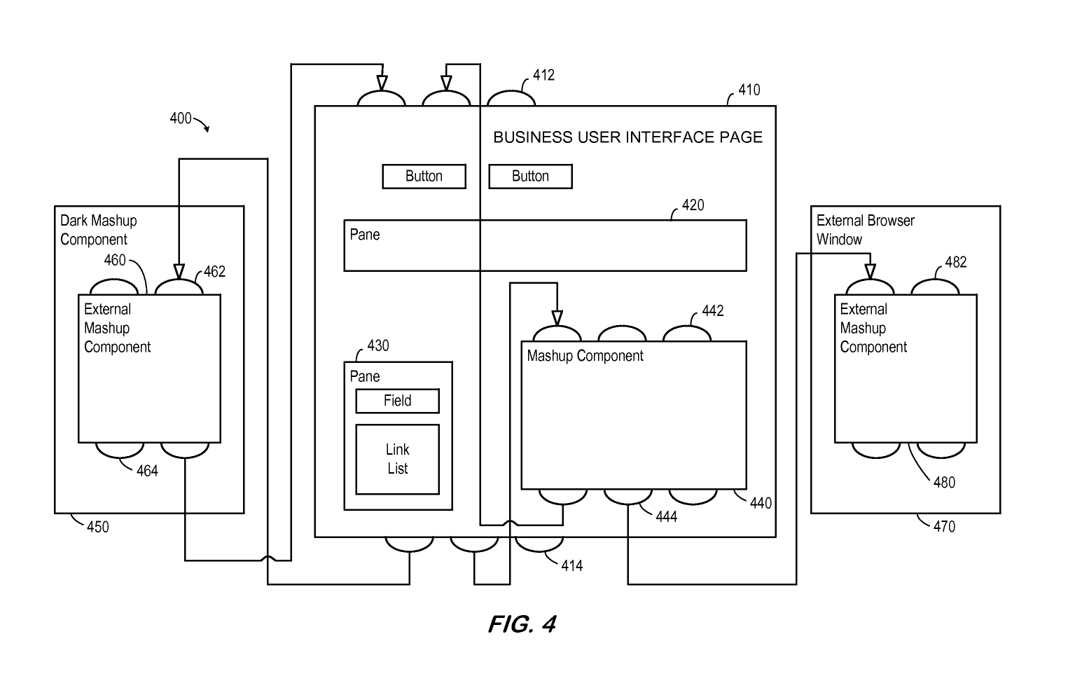

Note that embodiments described herein might be implemented in any of a number of different ways. One potential framework will now be described for the purpose of illustrating some embodiments. For example, FIG. 4 illustrates some integration types and mashup components in accordance with some embodiments described herein. In particular, a system 400 includes a business user interface page 410 having standard web panes 420, 430. The business user interface page 410 further includes a number of in-ports 412 to receive data from other components and out-ports 414 to provide data to other components. For example, one in-port 414 receives data from an out-port 464 of an external mashup component 460 associated with a dark mashup component 450 (that is, a component without user interface interaction). Moreover, one out-port provides data to an in-port 462 of the external mashup component 460.

According to some embodiments, the business user interface page 410 further includes a mashup component 440 with a number of in-ports 442 to receive data from other components and out-ports 444 to provide data to other components. For example, an in-port 442 receives data from an out-port 414 of the business user interface page 410. Moreover, one out-port 444 provides data to an in-port 412 of the business user interface page and another out-port 444 provides data to an in-port 482 of an external mashup component of a browser window 470.

According to some embodiments, the system 400 is associated with a generic web services framework having mashup model extensions and external RESTful service adapters. The system 400 may further be associated with a RESTful generic web services proxy for cross-site content access, and a generic runtime Mashup services piping controller on the client side.

According to some embodiments, the system 400 is associated with generic Mashup components, including: non-visual modeled mashup components for FP2.0 Mashup web services (which may include data write-back via ports); generic modeled Silverlight Mashup components (e.g., RSS top news); custom Silverlight mashup components (e.g., Virtual Earth map which could be provided by an RSS or .NET DLL); generic modeled JavaScript Mashup components (e.g., URLViewer); and/or custom JavaScript Mashup components (e.g., a Facebook application or web widget which could be provided via HTML/JavaScript). Moreover, an XML/DSL based mashup user interface specific model language may contribute to the flexibility and extensibility throughout a products lifecycle independent from the technology changes and/or evolutions that may occur.

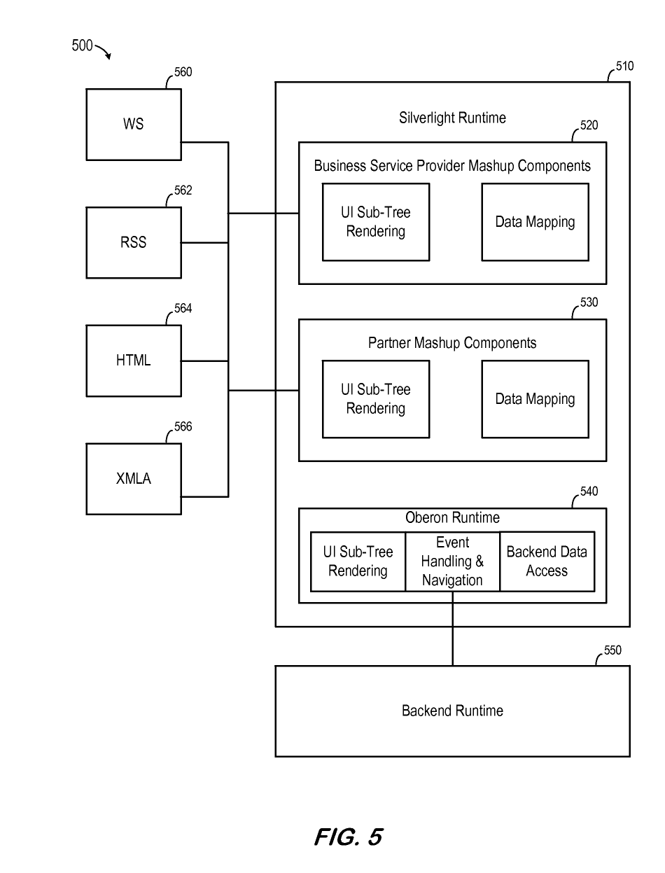

FIG. 5 is a block diagram of some mashup components at run time. In particular, the system 500 includes a Silverlight runtime element 510 with business service provider mashup components 520, partner mashup components 530, and an Operating System (OS) runtime element (e.g., an Oberon runtime). The business service provider mashup components 520 and partner mashup components 530 may, for example, each support user interface sub-tree rendering and data mapping in connection with WS components 560, RSS components 562, HTML components 564, and/or XML for Analysis (XMLA) components 566. The OS runtime element 540 might support user interface sub-tree rendering, event handling and navigation, and backend data access with a backend runtime element 550.

Note that the components described herein might be associated with generic mashup components that provide a fixed (but customizable) way to display data, implement in-port and out-ports for use in navigations, and/or provide a mechanism to map parameters from ports to service requests and/or responses Moreover, the generic mashup components may implement service proxies to invoke service calls as well as provide means to configure the service invocation (e.g., address, security, and/or protocol). According to some embodiments, generic mashup components may be configured per service (e.g., configure how to display data), define port-types, map parameters from ports to service requests, and/or to configure service invocation.

Examples of components that may be supported according to some embodiments, include: “dark” mashup components (with no user interface contribution) that call SOAP or RSS/Atom web services; HTML mashup components that display HTML in a browser-control (internal) or in a browser window (external) and request HTML pages over HTTP/HTTPS; analytics mashup component that display data in charts or grid and call XMLA services over SOAP; and generic table mashup components that display data in a generic table and call SOAP, RSS/ATOM, XMLA elements.

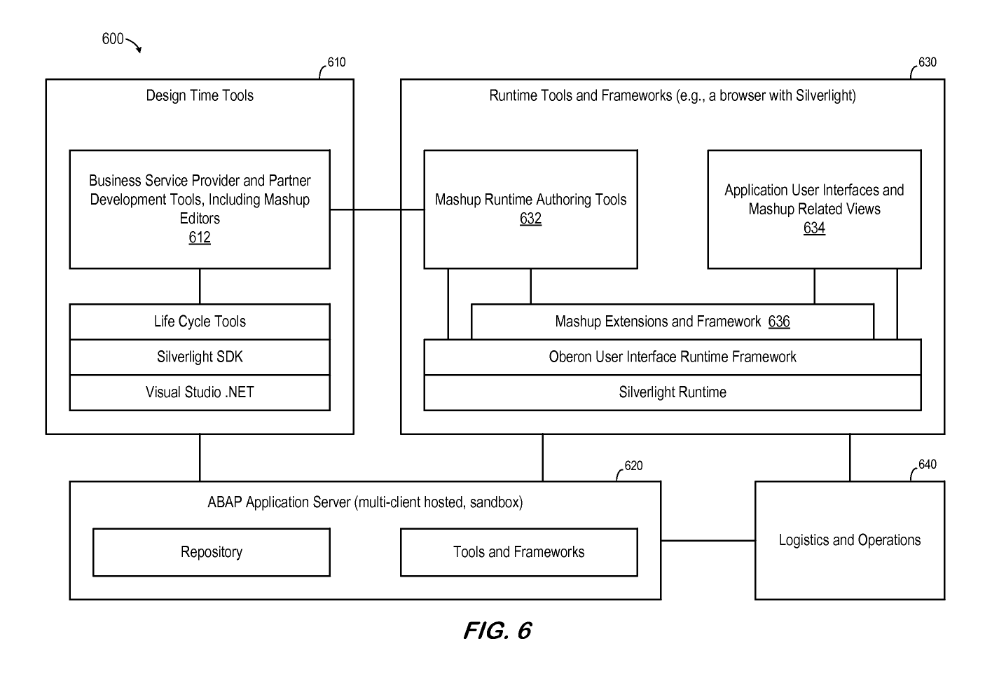

FIG. 6 is a system architecture 600 according to some embodiments. In particular, design time tools 610 may include development tools 612 associated with a design-time Integrated Development Environment (IDE), a user interface designer, and/or mashup editors (e.g., having a mashup registry, components, and port types). According to some embodiments, the development tools 612 communicate with an ABAP application server 620 through life cycle tools, a Silverlight Software Development Kit (SDK), and a Visual Studio .NET layer.

The development tools 612 may also communicate with mashup authoring tools 632 of a runtime tools and frameworks element 630 (e.g., a browser with Silverlight). According to some embodiments, the runtime tools and frameworks element 630 further supports application user interfaces (e.g., work centers and floorplans) and mashup related views 634

The mashup authoring tools 632 and application user interfaces and mashup related views 634 may each communicate with a Silverlight runtime via an Oberon user interface runtime framework. The mashup authoring tools 632 and application user interfaces and mashup related views 634 may each also communicate with the Silverlight runtime via a mashup extensions and framework 636 (e.g., supporting (i) mashup custom extensions and custom panes and (ii) a mashup web services runtime framework) and the Oberon user interface runtime framework. The runtime tools and frameworks element 630 may exchange information with a logistics and operations element 640 (e.g., that provides monitoring and support functions as well as static third party mashup resources).

According to some embodiments, the ABAP application server 620 is associated with a multi-client, hosted sandbox having a Repository (for user interface components, mashup components, a mashup registry, and/or a mashup global port type package) along with tools and frameworks (e.g., associated with an Oberon backend, business objects, a generic web services proxy, and/or mashup framework APIs).

End User Personalization

According to some embodiments, an end user has the same possibilities of personalization regarding mashup components as compared to other user interface components. That is, if a client desires, an end user might be given the right to configure mashup components (and the changes will only impact his or her display). An end user might, for example, move the location of a mashup component, hide or show components, change the order of table-columns, and/or rename fields.

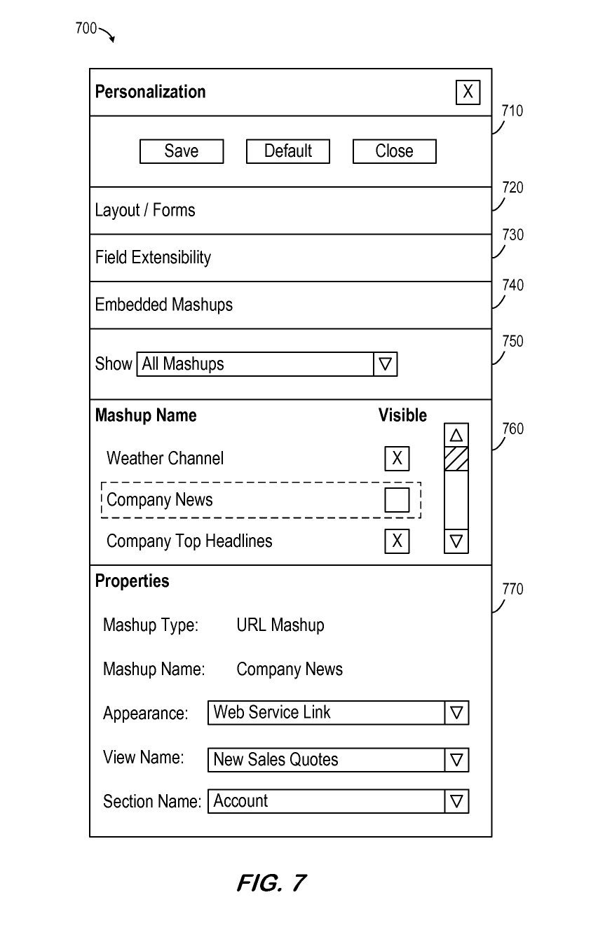

FIG. 7 illustrates an end user mashup personalization side panel 700 associated with a URL mashup according to some embodiments. The side panel 700 includes a selection area 710 (e.g., where he or she can save changes, restore default values, and/or close the panel 700) and normal options to work on layout/forms 720 or field extensibility 730. The panel 700 further includes an embedded mashups option 740 that, when selected, will let the user determine which mashups should be shown 750 (e.g., all mashups, or only URL mashups). A list 760 of mashup names is shown based on the end user's selection along with a “visibility” option for each mashup name. Note that if there are multiple ports available for the same port type, the mashup entry might be shown multiple times. For example:

Map/Directions
AddressInfoOutShipTo

Map/Directions
AddressInfoOutBillTo

The properties 770 of the mashup name selected in the list 760 are also displayed. For a URL mashup, the properties 770 might include the mashup type, the mashup name, an appearance property (e.g., web service link or web service menu), a view name, and a section name.

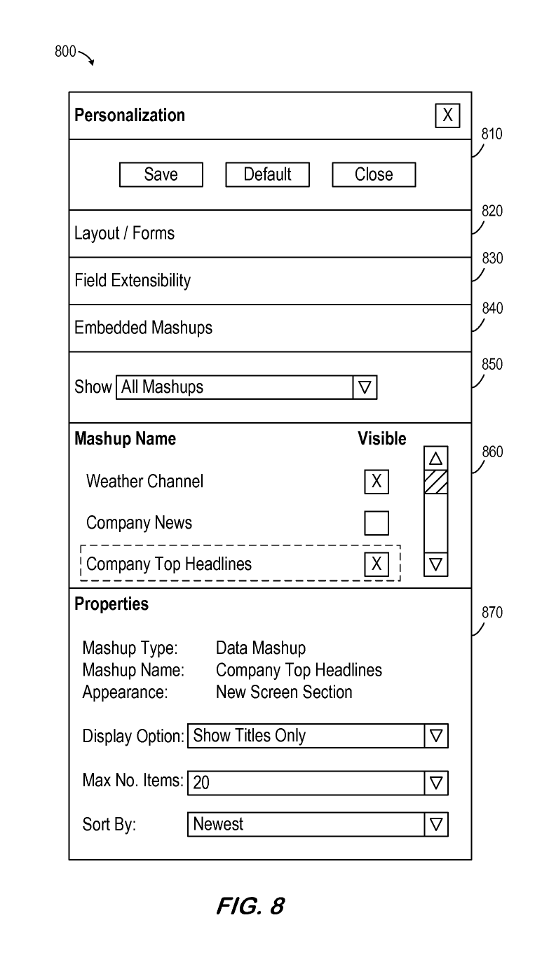

Similarly, FIG. 8 illustrates an end user mashup personalization side panel 800 associated with a data mashup according to some embodiments. As before, the side panel 800 includes a selection area 810 (e.g., where he or she can save changes, restore default values, and/or close the panel 800) and normal options to work on layout/forms 820 or field extensibility 830. The panel 800 further includes an embedded mashups option 840 that, when selected, will let the user determine which mashups should be shown 850 (e.g., all mashups, or only data mashups). A list 860 of mashup names is shown based on the end user's selection along with a “visibility” option for each mashup name. The properties 870 of the mashup name selected in the list 860 are also displayed. For a data mashup, the properties 870 might include the mashup type, the mashup name, an appearance property (e.g., whether or not the mashup should be displayed in a new screen section), a display option (e.g., show title only, show summary, or show summary with image), a maximum number of times to be displayed to the end user, and a sorting selection (e.g., newest or oldest first).

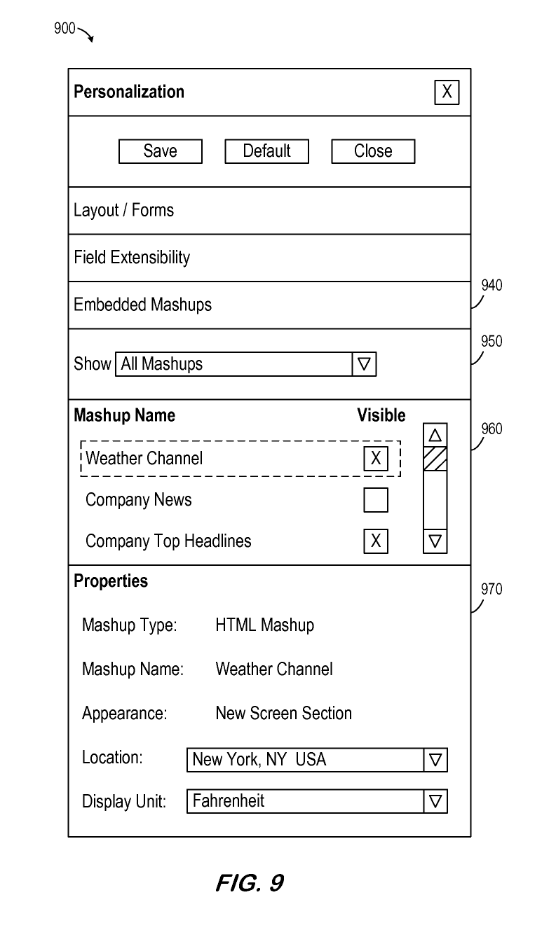

Finally, FIG. 9 illustrates an end user mashup personalization side panel 900 associated with an HTML mashup according to some embodiments. Once again, the panel 900 includes an embedded mashups option 940 that, when selected, will let the user determine which mashups should be shown 950. A list 960 of mashup names is shown based on the end user's selection along with a “visibility” option for each mashup name. The properties 970 of the mashup name selected in the list 960 are also displayed. For an HTML mashup, the properties 970 might include the mashup type, the mashup name, an appearance property, a location selection (e.g., geographically where the end user is located), and a display unit selection (e.g., Fahrenheit or Celsius).

Note that mashup components might be bound to out-plugs and in-plugs of business service provider pages. The out-plugs might be fired as a result of different kinds of events. If a plug fires, mashup components might either open an external browser window, synchronize the content of an internal view, or just retrieve some data and feed it back into other components. Some examples of how a user may trigger an event include: selecting an item from a drop-down list of services, clicking on a link, change the selection in a table, and clicking on a certain area in a map.

According to some embodiments, an end-user mashup personalization side panel might add FP2.0 web services into a section group or a “web services” button. Note that out-ports and in-ports (which may be for write-back case only) navigations may be done via the added user interface event handlers and views in the parent embedding component. The side panel might also add context-sensitive RSS web top news into a new section group. In this case, out-ports of the parent embedding component may be consumed by the embedded mashup components via implicit navigations triggered by data value change events. The side panel might also add third party widgets or JavaScript/HTML mashups. For example, mashup components could be embedded into the parent component with or without the any numbers of out-port and in-port navigations (depends on the different cases).

Note that according to some embodiments, the end user can personalize the pages that carry mashup components in the same way as he or she does with “normal” pages. Optionally, an end-user might be given the key user tools for the configuration of mashup components. In the hands of the end user (without special key user rights), the configuration tools will only change his or her personal settings and have no client wide effect.

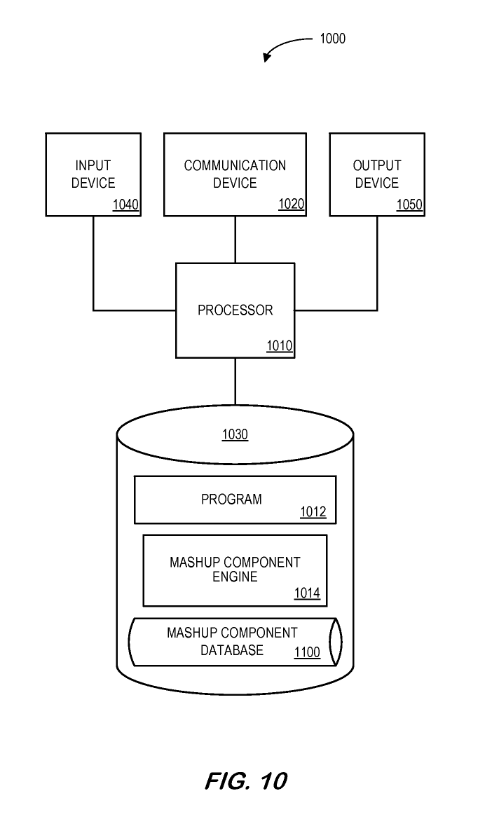

Embodiments of the present invention may be associated with various types of business service provider, partner, and/or client hardware systems. For example, FIG. 10 is a block diagram of a mashup platform 1000 according to some embodiments. The mashup platform 1000 may be, for example, associated with any of the devices described herein. The mashup platform 1000 comprises a processor 1010, such as one or more commercially available Central Processing Units (CPUs) in form of one-chip microprocessors, coupled to a communication device 1020 configured to communicate via a communication network (not shown in FIG. 10). The communication device 1020 may be used to communicate, for example, with one or more client devices or business service providers. The mashup platform engine 1000 further includes an input device 1040 (e.g., a mouse and/or keyboard to enter content defining a mashup component) and an output device 1050 (e.g., a computer monitor to display information about a mashup component).

The processor 1010 communicates with a storage device 1030. The storage device 1030 may comprise any appropriate information storage device, including combinations of magnetic storage devices (e.g., a hard disk drive), optical storage devices, and/or semiconductor memory devices.

The storage device 1030 stores a program 1012 and/or mashup component application 1014 for controlling the processor 1010. The processor 1010 performs instructions of the programs 1012, 1014, and thereby operates in accordance with any of the embodiments described herein. For example, the processor 1010 may establish a business user interface page associated with a business service provider. The user interface page may have, for example, at least one in-port to receive data from components and at least one out-port to provide data to components. The processor 1010 may further embed a mashup component within the business user interface page, and the mashup component may have at least one out-port to provide data to components. According to some embodiments, the processor 1010 facilitates a display of the user interface page to a client, including the embedded mashup component, wherein the mashup component: (1) consumes business context data, and (2) combines and displays data received from a plurality of external data sources. Note that the establishing, embedding, and/or facilitating may all be performed by a business service provider.

The programs 1012, 1014 may be stored in a compressed, uncompiled and/or encrypted format. The programs 1012, 1014 may furthermore include other program elements, such as an operating system, a database management system, and/or device drivers used by the processor 1010 to interface with peripheral devices.

As used herein, information may be “received” by or “transmitted” to, for example: (i) the mashup platform 1000 from another device; or (ii) a software application or module within the mashup platform 1000 from another software application, module, or any other source.

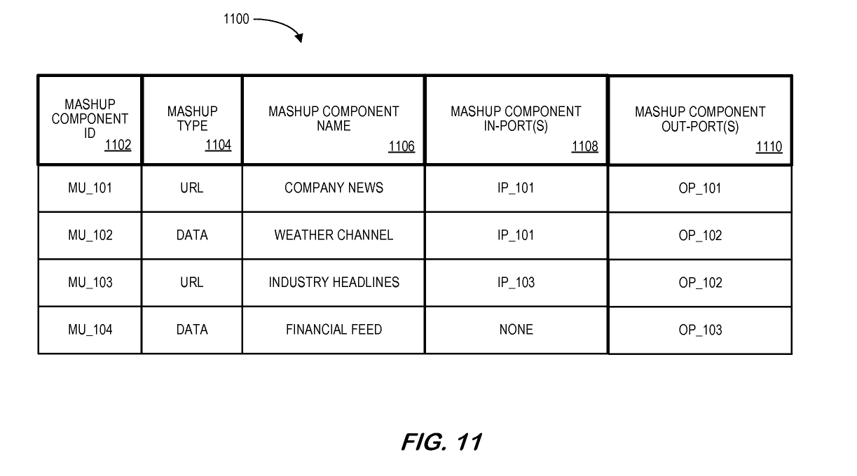

In some embodiments (such as shown in FIG. 10), the storage device 1030 stores a mashup component database 1100 to facilitate the creation of mashup components for a user interface page. One example of a database 1100 that may be used in connection with the mashup platform 1000 will now be described in detail with respect to FIG. 11.

Referring to FIG. 11, a table is shown that represents the mashup component database 1100 that may be stored at the mashup platform 1000 according to some embodiments. The table may include, for example, entries defining mashup components that may be included on a user interface page. The table may also define fields 1102, 1104, 1106, 1108, 1110 for each of the entries. The fields 1102, 1104, 1106, 1108, 1110 may, according to some embodiments, specify: a mashup component identifier 1102, a mashup type 1104, mashup component name 1106, one or more mashup component in-ports 1108, and one or more mashup component out-ports 1110. The information in the mashup component database 1100 may be created and updated, for example, based on information received from a user interface designer.

The mashup component identifier 1102 may be, for example, an alphanumeric code associated with a particular mashup component that might be included on a user interface page. The mashup type 1104 and mashup name 1106 may further define the component (e.q., as a URL or data type component). The mashup component in-ports 1108 and out-ports 1110 may define how the component is to receive and or provide data as appropriate.

The embodiments described herein are solely for the purpose of illustration. Those in the art will recognize other embodiments may be practiced with modifications and alterations limited only by the claims.

What is claimed is:

1. A computer implemented method, comprising:
establishing a business user interface page associated with a business service provider, the user interface page having at least one in-port to receive data from components and at least one out-port to provide data to components;
embedding a mashup component within the business user interface page, the mashup component having at least one out-port to provide data to components; and
facilitating a display of the user interface page to a client, including the embedded mashup component, wherein the mashup component: (1) consumes business context data, and (2) combines and displays data received from a plurality of external data sources.

2. The method of claim 1, wherein the mashup component is further associated with write-back data from a user selection to the business user interface page.

3. The method of claim 1, wherein the mashup component further has at least one in-port to receive data from components, wherein an out-port of the user interface page is coupled to an in-port of the mashup component.

4. The method of claim 3, wherein an in-port of the user interface page is coupled to an out-port of the mashup component.

5. The method of claim 3, wherein an out-port of the mashup component is coupled to an in-port of an external browser window.

6. The method of claim 1, further comprising:
receiving key user personalization data, wherein said facilitating the display of the user interface page to the client is performed in accordance with the key user personalization data for multiple end users.

7. The method of claim 1, further comprising:
receiving end user personalization data from a first end user, wherein said facilitating the display of the user interface page to the client is performed in accordance with the end user personalization data for the first end user but not for a second end user.

8. The method of claim 1, further comprising:
wiring at least one in-port or out-port of the mashup component to another component.

9. The method of claim 8, wherein the other component is associated with at least one of: (i) a dark component without user interface interaction, (ii) an HTML component, (iii) an analytics component, or (iv) a generic table component.

10. The method of claim 1, wherein at least one of the external data sources is associated with at least one of: (i) a really simple syndication feed, (ii) Atom information, (iii) an XML-based Web syndication format, (iv) a search engine, or (v) a simple object access protocol request.

11. The method of claim 1, wherein the mashup component is associated with at least one of: (i) C#, (ii) XAML, (iii) HTML, (iv) JavaScript, or (v) XML.

12. The method of claim 1, wherein the mashup is displayed as one of: (i) an external browser window, or (ii) an embedded control.

13. A computer-readable medium storing program code executable by a computer to:
establish a business user interface page associated with a business service provider, the user interface page having at least one in-port to receive data from components and at least one out-port to provide data to components;
embed a mashup component within the business user interface page, the mashup component having at least one out-port to provide data to components; and
facilitate a display of the user interface page to a client, including the embedded mashup component, wherein the mashup component combines and displays data received from a plurality of external data sources.

14. The medium of claim 13, wherein the mashup component is further associated with write-back data from a user selection to the business user interface page.

15. The medium of claim 13, further comprising:
receiving key user personalization data, wherein said facilitating the display of the user interface page to the client is performed in accordance with the key user personalization data for multiple end users.

16. The medium of claim 13, further comprising:
receiving end user personalization data from a first end user, wherein said facilitating the display of the user interface page to the client is performed in accordance with the end user personalization data for the first end user but not for a second end user.

18. A system, comprising:
a client apparatus; and
a business service provider apparatus in communication with said client apparatus via a communication network, wherein the business service provider apparatus is to:
establish a business user interface page associated with a business service provider, the user interface page having at least one in-port to receive data from components and at least one out-port to provide data to components;
embed a mashup component within the business user interface page, the mashup component having at least one out-port to provide data to components; and
transmit to client apparatus information to facilitate a display of the user interface page to a client, including the embedded mashup component, wherein the mashup component: (1) consumes business context data, and (2) combines and displays data received from a plurality of external data sources.

19. The system of claim 18, wherein the mashup component is further associated with write-back data from a user selection to the business user interface page.

20. The system of claim 18, wherein the business service provider apparatus is further to:
receive key user personalization data, wherein said facilitating the display of the user interface page to the client is performed in accordance with the key user personalization data for multiple end users.

21. The system of claim 18, wherein the business service provider apparatus is further to:
receive end user personalization data from a first end user, wherein said facilitating the display of the user interface page to the client is performed in accordance with the end user personalization data for the first end user but not for a second end user.
